(19) United States
(12) Patent Application Publication
(10) Pub. No.: US 2005/0062350 A1
(43) Pub. Date: Mar. 24, 2005

(54) Conductive greases and methods for using conductive greases in motors

(75) Inventors: Ming C. Kuo, Fox Point, WI (US); William R. Hoover, Grafton, WI (US); Marc W. Akkala, Cedarburg, WI (US); William L. Mehlhorn, Menomonee Falls, WI (US)

Correspondence Address: MICHAEL BEST & FRIEDRICH, LLP, 100 E WISCONSIN AVENUE, MILWAUKEE, WI, 53202, US

(73) Assignee: A.O. Smith Corporation, Milwaukee, WI (US)

(21) Appl. No.: 10/645,420

(22) Filed: Aug. 21, 2003

(51) Int. Cl. H02K 5/16; H02K 11/00

(52) U.S. Cl. 310/90; 508/410; 310/71

(57) ABSTRACT

A motor including a frame, a stator fixed relative to the frame, and a bearing assembly fixed relative to the frame may be provided. The bearing assembly may include ball bearings at least partially encompassed by a conductive grease. The conductive grease may include grease and particles including at least one of carbon, metal and a combination thereof. At least one particle may be coated with a conductive polymer. A rotor may be supported by the bearing assembly for rotation relative to the stator.

### BACKGROUND OF THE INVENTION

The present invention relates to conductive greases, and more particularly to conductive greases for reducing electrostatic discharge machining in bearing assemblies motors, particularly, electric motors.

One example of an electric motor is an induction motor. An induction motor is an alternating current motor that includes a frame, a stator fixed relative to the frame, and a rotor that rotates relative to the stator. A primary winding is positioned on the stator and a secondary winding (e.g., a wound secondary winding, a squirrel cage secondary winding) is positioned on the rotor. When the primary winding is electrically connected to an alternating current power source, a current is induced in the secondary winding. The alternating currents in the primary and secondary windings generate magnetic fields which interact to rotate the rotor relative to the stator.

To facilitate rotation of the rotor relative to the stator, the shaft of the rotor is commonly fitted with two ball bearing assemblies. Each ball bearing assembly includes a plurality of bearings positioned between an inner race and an outer race and at least partially encapsulated by insulating grease or oil based lubricant.

During operation of the induction motor, especially when a variable frequency power supply is utilized, capacitive coupling between the primary windings and the rotor assembly has been found to cause deterioration of the ball bearing assemblies. Such deterioration affects operation of the induction motor and necessitates maintenance or replacement of the bearing assemblies.

Charge builds up on the surface of the primary winding as current flows therethrough. As charge builds, parasitic capacitive coupling is caused between the primary winding and the rotor with the air gap between the stator and the rotor acting as a dielectric. Where the charge on the primary windings is negative, free electrons within the rotor are repelled and forced to the inside of the rotor. This leaves a positive charge on the external wall of the rotor and a negative charge centrally located within the rotor and along the shaft of the rotor and the inner race of the bearing assembly to which the rotor is connected. The insulating grease or oil-based lubricant in the bearing assembly also acts as a dielectric. Thus, the bearing assembly acts as a capacitor.

When subjected to a sufficiently intense field, a dielectric is prone to breakdown. During dielectric breakdown, the charge built up on either side of the dielectric rapidly flows through the dielectric causing a current. The field strength at which dielectric breakdown occurs depends on the dielectric characteristics and the gap size between adjacent conductors.

The air gap between the rotor and stator is generally wide enough that no breakdown occurs there. However, as the gaps between the ball bearings and the adjacent races are defined by a thin layer of lubricant, dielectric breakdown occurs frequently at these points. Often, such breakdown generates a spark or small explosion on one of the ball bearing surfaces due to rapid electron flow through the dielectric. When these sparks are large, they can pit and deform ball bearing surfaces, eventually adversely affecting operation of the bearing assembly. This ball deforming process is referred to herein as electrostatic discharge machining.

### SUMMARY OF THE INVENTION

In one aspect, the invention may provide a method of decreasing the ability of a grease to support a voltage when functioning in a motor. The method may comprise mixing conductive particles with the grease to form a conductive grease. The particles may comprise at least one of carbon, metal and a combination thereof, and be at least partially coated with a conductive polymer. The conductive grease may be less able to support a voltage when functioning in a motor than the grease.

In another aspect, the invention may provide a method of reducing electrostatic discharge machining in a motor, which tends to erode bearing surfaces of the motor. The method may comprise mixing conductive particles with a grease to form a conductive grease. The particles may be at least partially coated with a conductive polymer. The method may further comprise at least partially encompassing ball bearings of the motor with the conductive grease. The conductive grease may reduce electrostatic discharge machining in the motor, which erodes bearing surfaces of the motor, better than the grease.

In another aspect, the invention may provide a motor comprising a frame, a stator fixed relative to the frame, and a bearing assembly fixed relative to the frame. The bearing assembly may include ball bearings at least partially encompassed by a conductive grease. The conductive grease may comprise grease and particles comprising at least one of carbon, metal and a combination thereof. At least one particle may be coated with a conductive polymer. A rotor may be supported by the bearing assembly for rotation relative to the stator.

Further features of the present invention, together with the organization and manner of operation thereof, will become apparent from the following detailed description of the invention when taken in conjunction with the accompanying drawing.

### DESCRIPTION OF THE DRAWINGS

FIG. 1 is a schematic illustration of an induction motor.

### DETAILED DESCRIPTION OF THE INVENTION

The greases and methods described herein may be employed with a wide variety of motors. More particularly, the grease may be used with electric motors including, but not limited to, induction motors, brush DC motors, brushless DC motors, switched reluctance motors, as well as other types of electric motors and dynamoelectric machines. Brushless DC and switched reluctance motors have much poorer coupling (larger effective air gap) from the stator winding to the rotor. The details of the motors are commonly known in the art and, accordingly, not described in detail. Regardless of the motor, the bearing assemblies of the motors 10 may be packed with a conductive grease according to the invention that provides a continuous path for current to flow from the rotor to the grounded frame of the motor 10.

The conductive grease may comprise grease and a plurality of particles or filler material that is at least partially coated with or encapsulated by an inherently conductive polymer. The filler material may comprise metal particles, metal powder, carbon particles, carbon fibers, graphite particles and combinations thereof. Silver, aluminum, copper and lithium particles are specific examples of metal particles, whereas carbon black is one specific example of a carbon particle.

With respect to the actual greases used, many types of greases, lubricants, synthetic oils and standard mineral oils may be used. For example, the grease may comprise a wide variety of synthetic hydrocarbons, polyglycols, polyethers, diesters, polyesters, polyphenylethers and combinations thereof. Other examples of suitable greases include those comprising polyethers that are naturally polar. Nye Lubricants of Fairhaven, Mass. currently offers three suitable conductive greases:
Nyogel 753G—A stiff, carbon thickened, light viscosity, polyolester grease.
Nyogel 756G—A silica thickened, light viscosity, synthetic hydrocarbon grease.
Nyogel 758G—A stiff, lithium soap thickened, light viscosity, channeling synthetic ester grease.
   The volume resistivity of both Nyogel 753G and Nyogel 756G is approximately 30 ohm-cm. Volume resistivity of Nyogel 758G is approximately 300 ohm-cm. Nyogel 753G and Nyogel 758G are both excellent channeling bearing grease. Each may rely primarily on a synergistic effect among its additives, not carbon or metallic filler, to create an electron pathway through the grease.

Performance of carbon and metal particles that are widely used as electrically conductive filler material for greases may be enhanced using a thin coating of conductive polymer without losing their electrical or physical characteristics. These coated particles may then be added to the grease. The conductive polymer maintains the electrical integrity of the particle while shielding the carbon or metal surface from reacting and adsorbing chemicals and polymeric additives. In the absence of the polymeric coating, the surfaces of the carbon particles eventually become passivated and may cause the conductive failure of the whole particle. The coated carbon or metal particles may have the ability to maintain electrical conductivity following long term exposure to chemicals and polymer additives when used in conjunction with greases for bearings assemblies of the motor.

As a result, electrically conductive compositions can be provided, which include a plurality of carbon or metal particles, some or all of which have a thick coating of conductive polymer thereon. The particles have a thin coating of conductive polymer thereon in an amount that may be sufficient to provide a coating weight greater than about 1 wt %, and more particularly, greater than about 3 wt %, and even more particularly, greater than about 5 wt % of the filler material. The coating weight may be less than about 75 wt %, and more particularly, less than about 50 wt % of the filler material. The particles may be in the form of discrete uniformly sized particles each of which has a thin coating of conductive polymer. Coated carbon particles may also exist in the form of coated aggregates of carbon particulates. Coated aggregates of particles in which more than one discrete carbon or metal particulate forms an aggregate which itself has a thin coating of conductive polymer are within the definition of coated particles. The compositions may also be in the form of free flowing coated particles. In other words, the compositions may be restricted in the amount of conductive polymer and include enough polymer to form a thin conductive coating on each particle.

The thin conductive polymer coating formed by the methods described herein allows the coated carbon or metal particles to retain the bulk electrical characteristics of uncoated carbon or metal particles. As such, the coating of conductive polymer serves largely as a protective electrical interconnection between the carbon or metal particle and its surrounding environment.

With respect to a motor, e.g. induction motor 10, use of the conductive grease in the bearing assemblies provides a continuous path for current to flow from the rotor to the frame that is grounded. Thus, capacitive coupling between the primary and secondary windings does not result in a buildup of charge across the bearing assembly. Reduction of the charge buildup correlates to a reduction in electrostatic discharge machining in the bearing assembly, thus prolonging the useful life of the bearing assemblies in the motor. The bearing may act as a capacitor. Since the grease is ohmic, however, the charge is constantly being bled off. The magnitude of the charge buildup may be reduced to a level that is too low to allow any arcing to occur.

Carbon particles are widely available from commercial sources such as Degussa Corporation and Cabot. Suitable forms of carbon particles include carbon particles of varying graphitic content, size, morphology and shape. Particle sizes can range from sub-micron particulates to fibers having diameters of up to 20 microns and aspect ratios as high as 1 to 100. The surface area of carbon or metal particles may be greater than 100 m²/gram, and more particularly, at least 200 m²/gram. The surface area may be as high as 2000 m²/gram. Those skilled in the art will appreciate that carbon particles and carbon black in particular have physical and electrical conductivity properties which are primarily determined by the structure, particle size, morphology and surface chemistry of the particle. The same properties may or may not apply to metal particles of the invention.

More particularly, carbon black particle structures can range from highly structured tree-like shapes to minimally structured rod-like shapes. Typically, the conductivity of carbon particles increases with increases in the structure of the particle from low structure to fine structure. Associated with the increase in structure is an increase in surface area which also increases conductivity. Similarly, the conductivity of highly crystalline or highly graphitic particles is higher than the conductivity of the more amorphous particles. The particular choice of size, structure, and graphitic content depends upon the physical and conductivity requirements of the coated carbon particle.

Some of the more useful classes of conductive polymers used to coat the particles include unsaturated or aromatic hydrocarbons as well as nitrogen, sulfur, or oxygen containing compounds. The polymers may comprise, but are not limited to, conductive forms of polyacetylene, polyphenylene, polyphenylenevinylene, polypyrrole, polyisothianaphthene, polyphenylene sulfide, polythiophene, poly(3-alkylthiophene), polyazulene, polyfuran, polyaniline and combinations thereof. Conductive forms of polyaniline include self-doped, sulfonated polyaniline which is conductive without external doping.

Polyaniline can occur in several general forms including a reduced form having the general formula

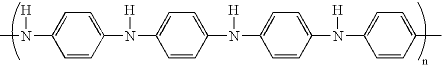

a partially oxidized form having the general formula

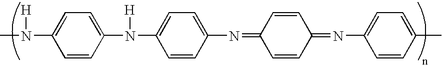

and the fully oxidized form having the general formula

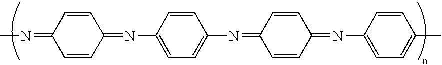

Each of the above illustrated polyaniline oxidation states can exist in its base form or protonated form. Typically, protonated polyaniline is formed by treating the base form with protonic acids, such as mineral and/or organic acids. The electrical properties of polyaniline vary with the oxidation states and the degree of protonation, with the base forms being generally electrically insulating and the protonated form of polyaniline being conductive. Accordingly, by treating a partially oxidized base form of polyaniline, a salt having an increased electrical conductivity of approximately 1-10 S/cm may be formed.

The preparation and properties of polyaniline, both its non-conductive and “free base” form and its conductive “acid” form, are well documented in the literature. For example, U.S. Pat. Nos. 5,008,041, 4,940,517, 4,806,271, and 6,132,645 disclose methods for preparing polyaniline under a variety of conditions for obtaining different molecular weights and conductivities. Each of these patents is hereby incorporated by reference. Typically, polyaniline is prepared by polymerizing aniline in the presence of a protonic acid and an oxidizing agent resulting in the “acid” protonated conductive form of the polymer.

Particles having a coating of conductive polymer can be prepared utilizing in situ methods by forming conductive polymer in a reaction mixture which incorporates particles in an amount sufficient to provide each of the particles with a coating of from approximately greater than 1 wt %. The particles may have a coating that is less than about 75 wt % conductive polymer. The conductive polymer may be separated from the reaction to provide an electrically conductive composition. When polyaniline is the selected conductive polymer the coating process may be accomplished by forming a slurry of deaggregated and wetted carbon or metal particles in a reaction mixture of a solution of solvent, protonic acid, aniline, and other additives such as suitable oxidants. The reaction mixture also includes dianiline in an amount sufficient to provide the desired polyaniline molecular weight according to known polyaniline synthetic methods. As conductive polyaniline forms it coats the surface of the carbon particles, slowly precipitating a thin, adherent conductive coating. Typically the polymerization process occurs at temperatures between 0-80° C. Once collected and washed the coated particles are suitable for incorporating into a suitable resin or matrix material as filler material, forming a conductive polymeric composition.

Alternatively, carbon or metal particles can be coated with conductive polymer by first forming a mixture of deaggregated carbon or metal particles in a solution of polymer and then causing the polymer to precipitate onto the particle by adding water or other non solvent for the polymer to the mixture. The coated particles are then suitably collected, washed and dried. Typically, when polyaniline is the polymer of choice, the solution of polymer is a solution of free-base polyaniline in its undoped form. Accordingly, following the coating step the coated particles are converted to a conductive form by generating a coating of conductive polymer. This doping step is accomplished by forming a slurry of the coated carbon particles and aqueous solution of dopant. Suitable dopants are those protonic acids already mentioned which are useful in the synthesis of polyaniline.

One method for coating particles with polyaniline includes first deaggregating carbon or metal particles by stirring the particles in a suitable aqueous surfactant to form a slurry of at least one of carbon particle, metal particle and combination thereof. Suitable surfactants include any of a variety of ionic and nonionic surfactants as known in the art. Suitable surfactants are those which are additionally suitable in the polymer synthesis and as dopants for the conductive polymer. These surfactants include long chain alkyl substituted sulfonic acids such as those protonic acids having the formula

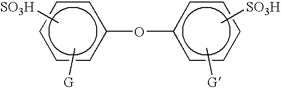

wherein G and G′ are independently hydrogen, lower alkyl, octyl, nonyl, or saturated or unsaturated linear or branched decyl, dodecyl, tetradecyl, hexadecyl, or octadecyl groups. Protonic acids belonging to this general class of compounds have surfactant properties which aid in dispersing and deaggregating carbon particles. Protonic acids may be selected from the group consisting of decyldiphenylether disulfonic acid and decylphenylether disulfonic acid.

Subsequent process steps include pre-wetting particles in an aqueous solution of protonic acid, combining aniline and dianiline with the wetted particles, cooling the slurry and adding an appropriate oxidant. The polymer forms in the presence of the particles and the polymer material actually coats the carbon black as the polymer forms. During the work-up step the carbon particles are collected, washed, and dried resulting in coated particles having a coating of from about 5 wt % to about 50 wt % conductive polyaniline.

An alternate method for coating particles with conductive polyaniline includes dissolving soluble free base polyaniline in a suitable solvent such as N-methyl pyrrolidinone, formamide, dimethylformamide or dimethylsulfoxide, forming a slurry of particles and then causing the dissolved polymer to precipitate onto the carbon particles.

Typically water is added to the slurry to cause the precipitation, however, other nonsolvents for the polymer are effective for precipitating the polymer. The coated particles are then dispersed in an aqueous solution of protonic acid as described above to produce the conductive acid-doped form of polyaniline.

When self-doped sulfonated polyaniline is the conductive polymer of choice, a method for preparing coated particles involves dissolving sulfonated polyaniline in an aqueous base to form a polymer solution, adding particles to form a slurry and then causing the polymer to precipitate onto the surface of the particles. The preferred aqueous base is aqueous ammonia or ammonium hydroxide. However, other suitable aqueous bases include aqueous solutions of metal hydroxides having the formula:
M(OH)ₙ,
wherein M is a metal having charge n, and n is an integer ≧1; compounds having the formula:
(NRR′R″R′″)OH
wherein R, R′, R″R′″ are independently H, alkyl, or aryl functionalities; and compounds having the formula:
NRR′R″
wherein R, R′, R″ are independently H, alkyl, or aryl functionalities

Typically, precipitating the polymer is accomplished by changing the pH of the polymer solution. More particularly, the pH of the aqueous system is caused to decrease causing the polymer to precipitate. Those skilled in the art will appreciate that adding a protonic acid to the aqueous system will cause the sulfonated polyaniline to precipitate. When aqueous ammonia or a volatile amine is the aqueous base, a preferred method for changing the polymer solution pH includes heating the polymer solution. This causes the base to leave the solution with a resulting drop in pH. Exposing the polymer solution to a vacuum aids the pH lowering process by causing the volatile amine.

Alternatively, particles having a coating of sulfonated polyaniline may be prepared using in situ methods similar to those discussed above. An exemplary method includes polymerizing amino-benzene sulfonic acid in 1 M HCL in the presence of a suitable oxidant and particle, e.g., carbon black. As the polymer chain develops the polymer precipitates from solution onto the surface of the carbon or metal particles, forming a thin coating of conductive polymer.

The method selected for preparing coated carbon particles or coated metal particles may be dispersed and relatively free of aggregates. Alternatively, aggregates which are present are small enough to maintain the structural and conductive characteristics of particles. Those skilled in the art will appreciate that once provided with a thin coating of conductive polymer, particles having the least amount of aggregates are less likely to shear or break into a significant number of particles having exposed uncoated portions of carbon or metal. The coating of conductive polymer protects the particle from conductive failure and provides other physical advantages.

Suitable methods for deaggregating particles include mechanical and ultrasonic dispersion techniques which are typically performed with the particles dispersed in aqueous systems containing a surfactant. Thus, for example, particles having a coating of conductive polyaniline can be prepared by dispersing carbon particles in an aqueous solution of TRITON X-100 available from Rohm & Haas. Then, following the effective deaggregation of the particles, a protonic acid, such as aqueous p-toluene sulfonic acid, aniline and/or dianiline and oxidant is charged into the dispersed mixture wherein the polymer forms and precipitates onto the particles.

When coated carbon or metal particles are prepared by polymerizing aniline in the presence of particles, the coated particles generally have a greater conductivity than precipitating free-base polyaniline onto carbon particles from a solution of the polymer. Moreover, when free-base polyaniline is precipitated onto particles from a solution of polyaniline the conductivity of the resulting coated particles is greater than the conductivity of material formed by merely combining neat conductive polyaniline and particles and pressing the combination into a pellet.

In view of the greater physical and chemical interactions that develop between the conductive polymer coating and particle formed by in situ polymerization techniques, in situ preparation methods are preferred. Additionally, when highly structured dendritic forms of carbon black are utilized, in situ polymerization techniques tend to preserve the fine tree-like structure in the final filler material. The slow deposition of polymer during in situ polymerization coating methods results in a more orderly polymer. Since ordering in conductive polymers is directly related to increased conductivity, the in situ polymerization deposition results in a higher bulk conductivity of the carbon particles. Furthermore, the in situ polymerization methods directly provide doped conductive polyaniline coating. This is in contrast to coatings formed during solvent precipitation methods which require further doping procedures in order to regenerate the conductive form. These final doping procedures may not form fully doped polymer to provide maximum conductivity for the composition.

The amount of conductive polymer formed on the surface of each particle may be the minimum amount necessary to provide a thin coating. Those skilled in the art will appreciate that less conductive polymer is necessary to provide a thin coating on each particle of a relatively low surface area conductive particle than the amount necessary to provide a thin coating on each particle of relatively high surface area particle. In fact, the weight percent of conductive polymer to the total weight of the coated particle can vary from perhaps 5% to 50% or even higher. Thus, particles having a surface area of about 250 m²/gm (XC-72 from Cabot Corp.) demonstrate good physical properties when provided with a thin conductive polymer coating which is approximately 20% of the weight of the total particle. However, carbon particles having a surface area of about 1000 m²/gm (XE-2 from Degussa Corp.) are not well coated at this percentage because of their much higher surface area. In the case of carbon particles having a surface area of 1000 m²/gm a coating weight which is equivalent to the weight of the carbon particle provides adequate coverage.

Those skilled in the art will appreciate that in addition to being dependent upon the amount and type of conductive polymer coating on the surface of the particles, the conductivity of the compositions of the present invention is dependent upon the shape, size and morphology of the carbon or metal particles. As discussed above, more highly structured graphitic carbon particles having dendritic shapes and high surface area are typically the most conductive forms. Similarly, coated carbon particles prepared from the more conductive forms of carbon particles is typically more highly conductive than filler prepared from particles having little structure and low graphitic content.

After adding the coated carbon or metal particles to the grease, the coated particles are typically greater than 0.2 wt % of the composition, more particularly, greater than about 0.5 wt %, and even more particularly, greater than about 1.0 wt %. The amount of coated particles in the final composition typically is less than about 30 wt %, more particularly, less than about 5 wt %, and even more particularly, less than about 3.0 wt %. The amount of particle can be higher than 30 wt %, however, this tends to be cost-prohibitive. In one embodiment, the amount of coated particles in the final conductive grease is about 1.8 wt %.

In terms of mixing the coated particles with the grease, any conventional mixing can be used. The final composition may be a homogenous or heterogeneous mix. Any conventional blender, mixer or processor may be used, each of which should be readily understandable by those having skill in the art. The mixing is generally undertaken at ambient conditions.

The final composition may or may not comprise additional components. For example, the composition may comprise thickeners, corrosion inhibitors, antioxidants, extreme pressure stability enhancers, other conductivity enhancers, and combinations thereof.

The conductive greases of the present invention may or may not have certain properties. Again, the conductive greases tend to have increased conductivity, which can be maintained for a longer period of time than conventional greases. In other words, the greases can maintain a lower volt range for a longer period of time than greases not containing the conductive polymers. These greases are more stable in a motor environment than other conventional greases for longer periods of time. Accordingly, the requisite amount of the conductive grease of the present invention that must be used is less than the requisite amount of conventional grease. Therefore, the conductive greases may be more cost-effective than conventional greases. Some of the greases discussed herein exhibit strong thermal-oxidative stability. In other words, many of the greases can a pass a 10,000 hour test in a motor.

### EXAMPLES

### Example 1

50.0 grams of Nyogel 753G was obtained from Nye Lubricants of Fairhaven, Mass.. Using a blender at ambient conditions, 0.9 grams of carbon black coated with polyaniline was mixed with the Nyogel 753G. The coated carbon black comprised about 1.8 wt % of the final grease. The conductive grease was employed in an induction motor, particularly, an A. O. Smith 7.5 HP E+3 induction motor. The grease at least partially encompassed the bearings. The conductive grease was able to pass a 10,000 hour test in the motor. To determine whether the grease “passed” the test, the following was measured: voltage on the shaft of the motor, and sound level produced by the bearings (sound was measured 1 foot axially off the end of the motor shaft). More particularly, the conductive grease “passed” the test, if the voltage on the shaft of the motor in which the grease was used exhibited less than 10 volts throughout the test. Moreover, the sound levels in motors in which passing greases were employed did not increase more than 6 decibels throughout the test. After completion of the test, the motors were disassembled, the bearings cut apart, and the races examined under an electron microscope as well.

### Example 2

50.0 grams of Nyogel 753G was obtained from Nye Lubricants of Fairhaven, Mass. The Nyogel 753G was employed in an induction motor, particularly, an A. O. Smith 7.5 HP E+3 induction motor. No particles having an inherently conductive polymer coated thereon were added to the grease. The grease at least partially encompassed the bearings. The Nyogel 753G was not able to pass a 10,000 hour test in the motor. In other words, the grease eventually was not able to dissipate the shaft voltage. As a result, the bearing races pitted slightly. The grease and test of Example 2 was the same as the grease and test of Example 1, except that particles having inherently conductive polymers thereon were added to the grease of Example 1.

### Example 3

The following is a comparison of the functioning of a standard motor with mineral oil based lubrication in the bearings and a motor with a conductive polymer enhanced conductive grease of the present invention in the bearings (the bearings and the motors being otherwise the same). The mineral oil based lubrication comprised Exxon Polyrex EM. For this example, the particular grease of the present invention comprised Nye Lubricant 753G, the particular conductive polymer comprised polyaniline, and the particle comprised carbon black. The grease comprised about 1.8 wt % coated particle.

The voltage waveform observed on the rotor while running was a very complex square wave with some amplitude modulation. To describe this waveform, the amplitude of most of the peaks (normal voltage) and of the biggest peaks (peak voltage) was recorded. The peak rotor voltage only occurred 1 or 2% of the time.

| | Elapsed | normal | peak | sound |
|---|---|---|---|---|
| Motor | Hours | voltage | voltage | level |
| mineral oil | 1596 | 15 | 25 | NA |
| conductive grease | 413 | 3 | 7 | NA |
| mineral oil | 2739 | 15 | 25 | not recorded |
| conductive grease | 2388 | 4.5 | 8.5 | 68 dB |
| mineral oil | 4784 | 15 | 25 | NA |
| conductive grease | 5047 | 4 | 7.5 | 74 dB |
| mineral oil | 7460 | 2.5 | 7.5 | NA |
| conductive grease | 7181 | 4 | 7.5 | 75 dB |
| mineral oil | 10000 | 15 | 30 | 74 dB |
| conductive grease | 10000 | 4 | 12 | 75 dB |

It can be seen from the data that the conductive grease enhanced with the inherently conductive polymer had lower overall rotor voltage throughout the test.

### Example 4

### Prophetic

50.0 grams of Nye 753, 50.0 grams of Nye 758, and 50.0 grams of standard mineral oil grease enhanced with 2% by weight carbon black coated with polyaniline are each employed in three separate motors, particularly, three A. O. Smith 7.5 HP E+3 induction motors. Additionally, two motors having 50.0 grams of standard mineral oil grease enhanced with 1% and 3%, respectively, carbon black coated with polyaniline may be tested. Each lubricant or grease's ability to pass the 10,000 hour test discussed above is tested.

1. A method of decreasing the ability of a grease to support a voltage when functioning in a motor, the method comprising:
mixing conductive particles with the grease to form a conductive grease, the particles comprising at least one of carbon, metal and a combination thereof, and being the particles at least partially coated with a conductive polymer, wherein the conductive grease is less able to support a voltage when functioning in a motor than the grease.

2. The method of claim 1, wherein at least one of the particles comprises carbon.

3. The method of claim 1, wherein at least one of the particles comprises carbon black.

4. The method of claim 3, wherein the polymer comprises polyaniline.

5. The method of claim 1, wherein at least one of the particles comprises metal.

6. The method of claim 1, wherein the polymer comprises at least one of polyacetylene, polyphenylene, polyphenylenevinylene, polypyrrole, polyisothianaphthene, polyphenylene sulfide, polythiophene, poly(3-alkylthiophene), polyazulene, polyfuran, polyaniline and a combination thereof.

7. The method of claim 1, wherein the polymer comprises polyaniline.

8. The method of claim 1, further comprising running the motor.

9. The method of claim 1, wherein the motor comprises at least one of an induction motor, a brush DC motor, a brushless DC motor and a switched reluctance motor

10. A method of reducing electrostatic discharge machining in a motor, which erodes bearing surfaces of the motor, the method comprising:
mixing conductive particles with a grease to form a conductive grease, the particles being at least partially coated with a conductive polymer; and
at least partially encompassing ball bearings of the motor with the conductive grease,
whereby the conductive grease reduces electrostatic discharge machining in the motor, which erodes bearing surfaces of the motor, better than the grease.

11. The method of claim 10, wherein the motor experiences longer bearing life when using the conductive grease than when using the grease.

12. The method of claim 10, wherein the motor exhibits less bearing noise when using the conductive grease than when using the grease.

13. The method of claim 10, wherein at least one of the particles comprises carbon.

14. The method of claim 10, wherein at least one of the particles comprises carbon black.

15. The method of claim 14, wherein the polymer comprises polyaniline.

16. The method of claim 10, wherein the polymer comprises at least one of polyacetylene, polyphenylene, polyphenylenevinylene, polypyrrole, polyisothianaphthene, polyphenylene sulfide, polythiophene, poly(3-alkylthiophene), polyazulene, polyfuran, polyaniline and a combination thereof.

17. The method of claim 10, wherein the polymer comprises polyaniline.

18. The method of claim 10, further comprising running the motor.

19. The method of claim 10, wherein the motor comprises at least one of an induction motor, a brush DC motor, a brushless DC motor and a switched reluctance motor.

20. A motor comprising:
a frame;
a stator fixed relative to the frame;
a bearing assembly fixed relative to the frame, the bearing assembly including ball bearings at least partially encompassed by a conductive grease, the conductive grease comprising grease and particles comprising at least one of carbon, metal and a combination thereof, at least one particle being coated with a conductive polymer; and
a rotor supported by the bearing assembly for rotation relative to the stator.

21. The motor of claim 20, wherein at least one of the particles comprises carbon.

22. The motor of claim 20, wherein at least one of the particles comprises carbon black.

23. The motor of claim 20, wherein at least one of the particles comprises a metal particle.

24. The motor of claim 20, wherein the polymer comprises at least one of polyacetylene, polyphenylene, polyphenylenevinylene, polypyrrole, polyisothianaphthene, polyphenylene sulfide, polythiophene, poly(3-alkylthiophene), polyazulene, polyfuran, polyaniline and a combination thereof.

25. The motor of claim 20, wherein the polymer comprises polyaniline.

26. The motor of claim 20, wherein the conductive grease is capable of functioning for at least 10,000 hours in the motor.

27. The motor of claim 20, wherein the motor comprising at least one of an induction motor, a brush DC motor, a brushless DC motor and a switched reluctance motor.
